(19) United States
(12) Patent Application Publication
(10) Pub. No.: US 2026/0204582 A1
(43) Pub. Date: Jul. 16, 2026

(54) NEGATIVE ELECTRODE COMPRISING A COATED CURRENT COLLECTOR

(71) Applicant: SAFT AMERICA, Cockeysville, MD (US)

(72) Inventors: Debanjan MITRA, Valdosta, GA (US); Rajesh BASKARAN, Hahira, GA (US); Evan ANDREWS, Valdosta, GA (US)

(73) Assignee: SAFT AMERICA, Cockeysville, MD (US)

(21) Appl. No.: 19/022,355

(22) Filed: Jan. 15, 2025

(51) Int. Cl. H01M 4/62; H01M 4/02; H01M 4/04; H01M 4/24; H01M 4/38; H01M 4/66; H01M 50/42; H01M 50/463

(52) U.S. Cl. CPC H01M 4/628; H01M 4/0404; H01M 4/045; H01M 4/0485; H01M 4/244; H01M 4/38; H01M 4/661; H01M 50/42; H01M 50/463; H01M 2004/021; H01M 2004/027

(57) ABSTRACT

The present disclosure relates to a negative electrode and a process for the preparation thereof. The negative electrode comprises a bismuth-coated current collector; and a negative electrode active material having an electrode potential ranging from −1.4V to −0.7V (vs. Mercury/mercuric oxide reference electrode).

### TECHNICAL FIELD

The present invention relates to the field of rechargeable batteries, and more specifically to negative electrodes, such as negative zinc electrodes, for use in rechargeable batteries.

### BACKGROUND

Various battery chemistries have been explored as alternatives to conventional lead acid and nickel cadmium rechargeable batteries.

Zinc has emerged as a particularly attractive material as a material for negative electrode material, because it is inexpensive and abundant along with a high theoretical specific capacity (0.819 Ah/g) and high voltage (E⁰=−1.2 V vs Standard hydrogen electrode in alkaline medium and −0.762 V vs standard hydrogen electrode in acidic medium). In contrast, cadmium is less abundant and contains a lower theoretical capacity of 0.477 Ah/g and a lower voltage (−0.809 V vs Standard hydrogen electrode).

Though rechargeable batteries containing negative zinc electrodes have been successfully developed and commercialized, the zinc electrodes in these batteries still face some challenges that are related either to the nature of the electrode active material or of the current collector. Electrochemical (e.g. copper) and chemical instability (e.g. copper and tin) of the current-collector, high-rates of hydrogen evolution from the current-collector (e.g. nickel, nickel-plated steel, and copper) and shape change of zinc electrodes during charge-discharge are some major factors that restrict the cycle life and the chargeability of zinc electrodes in secondary batteries.

Therefore, there remains a need to provide negative electrodes, in particular negative zinc electrodes, which function steadily for a large number of cycles without generating any significant amount of hydrogen, thus enabling providing high performance batteries with longer life. It would be also advantageous to be able to provide negative electrodes, in particular negative zinc electrodes, which do not suffer from shape changes upon charge-discharge.

### SUMMARY

The present invention relates to a negative electrode comprising:
a. a bismuth-coated current collector; and
b. a negative electrode active material having an electrode potential ranging from −1.4 to −0.7V (vs. Mercury/Mercuric Oxide reference electrode), and to an electrochemical cell comprising a negative electrode as disclosed herein.

The invention also relates to a process for preparing a negative electrode as disclosed herein. It comprises the steps of:
a. Providing a current collector;
b. Coating the current collector with bismuth or a bismuth-based mixture or alloy to obtain a bismuth-coated current collector; and
c. Assembling the bismuth-coated current collector with a negative electrode active material having an electrode potential ranging from −1.4 to −0.7V (vs. MMO) to provide a negative electrode.

Further aspects of the invention are as disclosed herein.

### BRIEF DESCRIPTION OF THE DRAWING

FIG. 1 represents the hydrogen evolution in two current collectors (bismuth-plated copper current collector and non-bismuth-plated copper current collector) as determined by Linear Sweep Voltammetry (LSV) (LSV from 0V vs. MMO to −1.5V vs MMO at 0.1V/sec, electrolyte comprising KOH, NaOH, LiOH, and balance water).

### DETAILED DESCRIPTION

The inventors have discovered that the use of a bismuth-coating on a current collector increases the electrochemical and chemical stability of the current collector and significantly reduces the hydrogen evolution rate compared to an uncoated current-collector.

More specifically, it was found that a bismuth-coated current collector shows the onset potential of hydrogen evolution being more negative to the zinc electrode reaction than uncoated current collector (see example). The onset potential of hydrogen evolution becomes more negative that the negative electrode charge potentials. Therefore, a bismuth-coated current collector is, in particular, able to eliminate the deficiencies of conventional copper or tin-plated copper current collectors used in zinc electrodes (e.g. electrochemical and chemical instability, high rates of hydrogen evolution). It can also be used in other negative electrodes, such as iron electrode.

Therefore, the present invention relates to a negative electrode comprising:
a. a bismuth-coated current collector; and
b. a negative electrode active material having an electrode potential ranging from −1.4 to −0.7V (vs. MMO reference electrode).

The nature and morphology of the current collector is not particularly limited and known materials and designs can be used as long as it is conductive. The current collector is typically based on, or made of, carbon or metal.

The term “based on” as used herein means that the current collector comprises the stated compound. The term “made of” as used herein means that the current collector consists of the stated compound.

The metal can be suitably selected from the group consisting of copper, nickel, steel, zinc, tin, titanium and any combinations or alloys thereof. It can be an electroplated material (e.g. nickel-plated steel or tin-plated copper).

The current collector may be one of the following: a mesh (e.g. metal mesh), an expanded metal, a metal foam (to increase the surface area of the negative electrode), a metal foil, a metal plate, a perforated metal, a non-perforated metal or a multi-layered support.

In some embodiments, the current collector is a two-dimensional conducting support such as a solid or perforated sheet (foil/plate), based on, or made of, carbon or metal.

In some embodiments, the current collector is a three-dimensional conducting support such as a metal mesh or a metal foam.

In some preferred embodiments, the current collector is based on copper, or is made of copper.

The current collector is coated with bismuth. The bismuth-coating protects the current collector from exposure to the electrolyte upon use of the electrode and reduces the hydrogen evolution rate. The bismuth-coating is stable with respect to the electrolyte, in particular in alkaline conditions.

The bismuth-coating may be a coating of bismuth (pure bismuth) or a coating of any bismuth-based mixtures or of any bismuth-based alloys.

A bismuth-based mixture or bismuth-based alloy designates a mixture or alloy comprising at least 2 wt % of bismuth.

The bismuth-coating has generally a thickness ranging from 2 to 10 μm, preferably from 4 to 6 μm. The thickness of the coating can be measured by any suitable means, in particular by gravimetric analysis, X-ray fluorescence spectroscopy, by cross-sectional focused ion beam scanning electron spectroscopy (FIB/SEM) analysis, by means of calipers or of a 4-point Resistivity probe.

The bismuth-coating can be applied on the current collector by any suitable methods known in the art. For instance, it can be applied by electrochemical plating or by molten metal casting on the current collector.

The bismuth-coating is applied on the external surface of the current collector. For example, when the current collector is a two-dimensional conducting support, the bismuth-coating may be applied on the two faces of the current collector or alternatively on only one of the two faces of the collector, the one facing the negative electrode active material. When the current collector is a three-dimensional conducting support, the bismuth-coating may be applied on each face of the current collector or alternatively on only one of them, the one facing the negative electrode active material.

The bismuth-coating may be continuous or discontinuous.

Preferably, the bismuth-coating is applied on the whole external surface (continuous coating on all faces) of the current collector providing a fully bismuth-coated current collector.

In some embodiments, the current collector is further coated with a functional coating applied on the bismuth-coating. The functional coating comprises one or more materials selected from the group consisting of zinc, nitrogen containing compounds, sulfur containing compounds, nitrogen and sulfur containing compounds and mixtures thereof. The functional coating applied on the bismuth-coating allows reducing the shape change of the negative electrodes, in particular of the zinc negative electrodes, by creating a homogenous electric field/current distribution during the charge-discharge. Dissolution of the active material of negative electrode and dendrite growth are reduced or even stopped. Reducing dissolution of the active material and dendrite growth allows multiple zinc electrodes to function in a stack configuration.

Examples of suitable nitrogen containing compounds include, but are not limited to, amines, imines, amino-acids, heterocyclic nitrogen compounds and mixtures thereof. Nitrogen containing compounds allow suppressing dendrites.

Examples of suitable sulfur containing compounds include, but are not limited to, thiols, sulfides, mercapto compounds and mixtures thereof. Sulfur containing compounds allow grain refining, they suppress nuclei size and promote more nucleation sites.

Examples of suitable nitrogen and sulfur containing compounds include, but are not limited to aminothiols (e.g. 4-aminothiophenol), thiocyanate and mixtures thereof. Nitrogen and sulfur containing compounds combine the effects of nitrogen containing compounds and sulfur containing compounds.

The functional coating can be applied by any suitable methods known in the art. For instance, it can be applied by dipping the bismuth-coated current collector into a solution containing any of the above-disclosed compounds.

The functional-coating has generally a thickness ranging from few monolayers to several micrometers. The thickness is preferably from 2 to 10 μm when the functional coating is made of zinc, and is a few monolayers for organic coatings (few nanometers thick for organic coating). The thickness of the coating can be measured by any suitable means as described herein above.

In some embodiments, the current collector may be coated with one or more layers of zinc and one or more layers of bismuth, providing a multi-layered structure of the type: current collector-(bismuth-zinc)ₙ with n ranging from 1 to 10.

The negative electrode comprises a negative electrode active material having an electrode potential ranging from −1.4V to −0.7V (vs. MMO reference electrode), preferably ranging from −1.4V to −1.1V (vs. MMO reference electrode), even more preferably ranging from −1.4V to −1.3V (vs. MMO reference electrode).

“MMO reference electrode” as used herein designates a mercury/mercuric oxide reference electrode in 20% potassium hydroxide solution.

The negative electrode active material is preferably selected from the group consisting of zinc-based material, iron-based material and mixtures thereof.

Zinc-based material as used herein designates zinc metal, zinc oxide or zinc alloys. Zinc-based material is typically in the form of particles.

Iron-based material as used herein designates iron metal, iron oxide or iron alloys. Iron-based material is typically in the form of particles.

In some embodiments, the negative electrode active material is a zinc-based material, preferably zinc metal.

In some preferred embodiments, the current collector is based on copper, or is made of, copper and the negative electrode active material is a zinc-based material, preferably zinc metal.

The negative electrode active material is typically applied on the bismuth-coating of the current collector or on the functional coating, when present. When the current collector is a two-dimensional conducting support, the negative electrode active material may be applied on both faces of the current collector or only one of the faces, the one that will be facing the separator upon use. When the current collector is a three-dimensional conducting support, the negative electrode active material may be applied on each face of the current collector or alternatively on only one of them, the one that will be facing the separator upon use.

The negative electrode of the present invention can further comprise a binder or gelling agent (e.g. polymeric binders, like vinyl polymers, acrylates or elastomers), a conductive material that increases the electronic conductivity of the electrode (e.g. graphite, carbon-based conductive materials, acetylene black or reduced graphene oxide, polyaniline (PANI)) and/or additives (e.g. inorganic or organic additives) that improve the performance and reversibility/stability of the negative electrode. These materials are typically mixed with the negative electrode active material and applied on the bismuth-coating of the current collector or on the functional coating, when present as described herein above. The amounts of a binder/gelling agent, conductive material, and other additives are not particularly limited, and suitable ratios are well known in the art.

In some embodiments, the negative electrode of the present invention comprises an ionic membrane that encloses the bismuth-coated current collector and the negative electrode active material. The negative electrode is thus physically contained in the membrane. The ionic membrane reduces or even stops the dissolution of the active material of the negative electrode in the electrolyte. When the negative electrode comprises a zinc-based active material, it will reduce or even stops dendritic growth of zinc. Instead of a direct electrolyte contact, an ionic pathway/channel will be established for the relevant ion (anions or cations) transport necessary during the zinc charge-discharge reaction isolating the active material from direct electrolyte contact

Various ion-transporting resin or membrane, such as non-porous polyacrylic acid (PAA) grafted polyolefins (e.g. polyethylene, polypropylene etc.) can be utilized as the ionic membrane.

The non-porous or low porosity polyolefin layer will stop the electrolyte from contacting the electrode surface whereas the PAA or the ionic moieties from the resins will conduct the ions (anions or cations) preventing active material, e.g. zinc, dissolution and dendritic growth.

The ionic membrane may be in the form of a pocket within which the electrode is contained and sealed. In some other embodiments, the ionic membrane may be fused to the active area of the electrode surface and completely contains the zinc electrode.

The skilled person will readily recognize that such an ionic membrane may be used to enclose any electrode. Thus, its use is not restricted to the enclosure of negative electrode comprising a bismuth-coated current collector and a negative electrode active material as disclosed herein. It can be used to enclose negative electrodes that comprise any current collector (coated and non-coated current collector) and any electrode active material. As such, it will inhibit active material dissolution, dendrite growth and cell shorting enabling flooded vented cell configuration. In addition, it will allow multiple electrodes, such as zinc electrodes, to function in a stack configuration. Therefore, the present invention also relates to an assembly comprising an electrode and an ionic membrane (as disclosed herein), the ionic membrane enclosing the electrode.

The negative electrode may be made by any suitable known methods.

In some embodiments, the negative electrode may be prepared by a process comprising the steps of:
a. Providing a current collector;
b. Coating the current collector with bismuth or a bismuth-based mixture or alloy to obtain a bismuth-coated current collector;
c. Optionally applying a functional coating on the bismuth-coated current collector; and
d. Assembling the bismuth-coated current collector, optionally further coated with a functional coating, with a negative electrode active material having an electrode potential ranging from −1.4 to −0.7V (vs. MMO reference electrode) to provide a negative electrode.

The bismuth-coating can be performed by electrochemical plating or by molten metal casting.

The negative electrode of the present invention can be coupled with any suitable electrolyte systems and cathodes to provide an electrochemical cell.

Hence, the present invention also relates to an electrochemical cell comprising a negative electrode as disclosed herein.

The electrolyte system is typically selected such as to provide suitable ionic conductivity viscosity and electrochemical potential window. The electrolyte system is preferably an alkaline electrolyte, such as an aqueous alkaline electrolyte (e.g. electrolyte comprising KOH, NaOH). Non-aqueous electrolytes are also contemplated.

The electrochemical cell may comprise a separator. The separator physically separates the two electrodes and prevent them from contacting each other to avoid short-circuit (e.g. ions permeable membranes). The use of a separator is not particularly limited and known separators for secondary batteries can be used. Conventional categories of separators include microporous membranes, nonwoven membranes, electrospun membranes, membranes with external surface modification, composite membranes, and polymer blends.

The cathode may comprise a current collector (as disclosed herein above) and a layer of material on the current collector which comprises a positive electrode active material, a binder or gelling agent, a conductive material and/or additives as disclosed herein above.

The positive electrode active material may be selected from the group consisting of silver-base material, nickel-based material, manganese dioxide and atmospheric oxygen.

The individual electrochemical cells of the present disclosure can be of any known type, such as cylindrical cell, button cell, prismatic cell (e.g. planar format).

In particular, the negative electrode of the present invention can be used in manganese-zinc, silver-zinc, nickel-zinc or metal-air batteries (e.g. zinc-air battery).

Multiple electrochemical cells can be arranged side by side in a common casing for providing a battery module.

Multiple electrodes in a stack will provide high energy density and power density from the electrochemical cells.

### EXAMPLE

### Assessment of Hydrogen Evolution in Bismuth-Plated Copper Current Collector vs. Copper Current Collector

Hydrogen evolution in two current collectors (bismuth-plated copper current collector and virgin copper current collector) was assessed by LSV (Linear Sweep Voltammetry) in the following conditions:

LSV from 0V vs. MMO to −1.5V vs MMO at 0.1V/sec, electrolyte comprising KOH, NaOH, LiOH, and balance water.

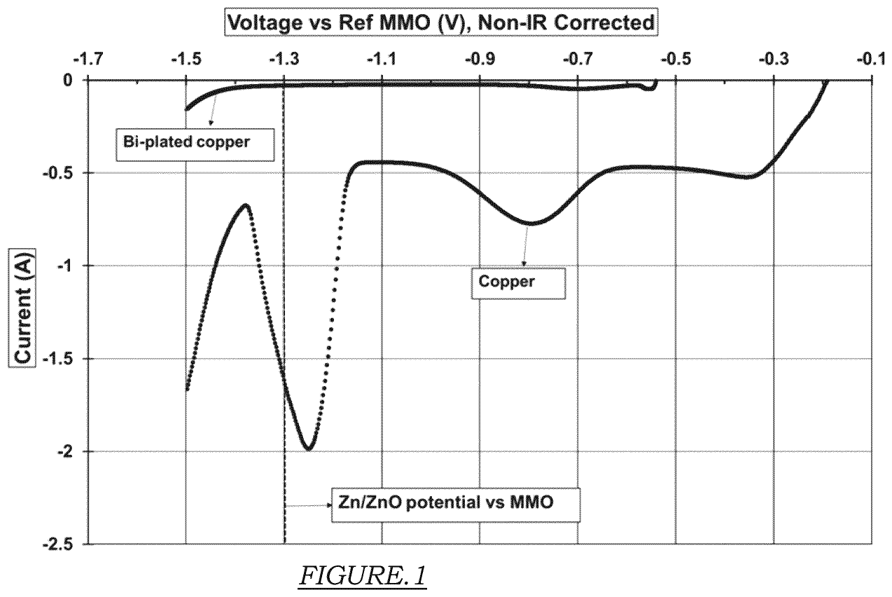

The results are presented on FIG. 1.

It can be noted that virgin copper current collector showed much higher current than bismuth-plated copper (Bi-plated copper) at voltages positive to −1.3 V vs MMO. It suggests that virgin copper has significant hydrogen evolution before zinc charging reaction.

Bi-plated copper shows current increase (hydrogen evolution) only at more negative voltages to −1.4 V vs MMO. Therefore, as a current collector, it will enable completion of any charging reaction (e.g., zinc, iron) that happens positive to −1.4 V vs MMO.

Also, copper showed multiple peaks indicating that copper by itself is not stable in alkaline solution (pH 14 or higher), and those peaks typically show the reduction of copper oxides to copper.

1. A negative electrode comprising:
a. a bismuth-coated current collector; and
b. a negative electrode active material having an electrode potential ranging from −1.4V to −0.7V (vs. Mercury/Mercuric Oxide reference electrode).

2. The negative electrode according to claim 1, wherein the current collector is based on, or made of, carbon or a metal selected from the group consisting of copper, nickel, steel, zinc, tin, titanium and any combinations thereof.

3. The negative electrode according to claim 1, wherein the current collector is made of copper.

4. The negative electrode according to claim 1, wherein the negative electrode active material has an electrode potential ranging from −1.4V to −1.1 V (vs. MMO).

5. The negative electrode according to claim 1, wherein the negative electrode active material has an electrode potential ranging from −1.4V to −1.3V (vs. MMO).

6. The negative electrode according to claim 1, wherein the negative electrode active material is selected from the group consisting of zinc-based material, iron-based material and mixtures thereof.

7. The negative electrode according to claim 1, wherein the negative electrode active material is a zinc-based material, preferably zinc metal, zinc oxide or zinc alloys.

8. The negative electrode according to claim 1, wherein the current collector is made of copper and the negative electrode active material is a zinc-based material.

9. The negative electrode according to claim 1, wherein the bismuth-coated current collector has a bismuth-coating having a thickness ranging from 2 to 10 μm.

10. The negative electrode according to claim 1, wherein the current collector is further coated with a functional coating applied on the bismuth-coating, the functional coating comprising one or more materials selected from the group consisting of zinc, nitrogen containing compounds, sulfur containing compounds, nitrogen and sulfur containing compounds, and mixtures thereof.

11. The negative electrode according to claim 10, wherein the nitrogen containing compound is selected from the group consisting of amines, imines, amino-acids, heterocyclic nitrogen compounds and mixtures thereof.

12. The negative electrode according to claim 10, wherein the sulfur containing compound is selected from the group consisting of thiols, sulfides, mercapto compounds and mixtures thereof.

13. The negative electrode according to claim 10, wherein the nitrogen and sulfur containing compound is selected from the group consisting of aminothiols, thiocyanates and mixtures thereof.

14. The negative electrode according to claim 1, further comprising an ionic membrane that encloses the current collector and the negative electrode active material.

15. The negative electrode according to claim 14, wherein the ionic membrane is made of non-porous polyacrylic acid (PAA) grafted polyolefins.

16. An electrochemical cell comprising a negative electrode according to claim 1.

17. The electrochemical cell according to claim 16 further comprising an alkaline electrolyte.

18. A process for preparing a negative electrode comprising the steps of:
a. Providing a current collector;
b. Coating the current collector with bismuth or a bismuth-based mixture or alloy to obtain a bismuth-coated current collector; and
c. Assembling the bismuth-coated current collector with a negative electrode active material having an electrode potential ranging from −1.4V to −0.7V (vs. MMO reference electrode) to provide a negative electrode.

19. The process according to claim 18, wherein coating the current collector with bismuth or with a bismuth-based mixture or alloy is performed by electrochemical plating or molten casting.
